(19) United States
(12) Patent Application Publication
(10) Pub. No.: US 2011/0186596 A1
(43) Pub. Date: Aug. 4, 2011

(54) CONTAINER FOR FLUID PRODUCTS, PARTICULARLY PHARMACEUTICAL, COSMETIC, FOOD PRODUCTS OR THE LIKE

(76) Inventor: Antonio Fontana, Carpi (MO) (IT)

(21) Appl. No.: 13/121,030

(22) PCT Filed: Aug. 5, 2009
(86) PCT No.: PCT/IB09/06457

§ 371 Date: Apr. 18, 2011

(30) Foreign Application Priority Data
Sep. 26, 2008 (IT) MO2008A000251

(51) Int. Cl. B65D 35/22; B67D 7/74

(52) U.S. Cl. 222/94; 222/129

(57) ABSTRACT

The container (1) for fluid products, particularly pharmaceutical, cosmetic, food products or the like, comprises a hollow body (2) inside which is defined a dividing wall (7) suitable for splitting up the inner volume of the hollow body (2) into two compartments (8, 9) for containing two fluid products (P1, P2), a neck (4) which extends from the hollow body (2) and which has two dispenser mouths (12, 13) for the fluid products (P1, P2), closing means (20, 21) for the dispenser mouths (12, 13) and a mixing element (14) which is associable with the neck (4) to define a mixing chamber (15) for the fluid products (P1, P2) exiting from the dispenser mouths (12, 13).

### CROSS-REFERENCE TO RELATED APPLICATIONS

This application claims the benefit of PCT International Patent Application No. PCT/IB2009/006457, filed Aug. 5, 2009, and Italian Patent Application No. MO2008A000251, filed Sep. 26, 2008, in the Italian Patent and Trademark Office, the disclosures of which are incorporated herein by reference.

### BACKGROUND OF THE INVENTION

1. Field of the Invention

The present invention relates to a container for fluid products, particularly suitable for containing products used in the pharmaceutical and cosmetic sector or in the medical and dental sector as well as in the food sector or the like.

2. Description of the Related Art

Containers made of polymer material for packaging one or more doses of fluid products, whether pastes, gel or liquids are known. Depending on the number of doses present, the known containers can be of the single-use or reclosable and pluridose type.

Generally, they comprise a containment body with a predetermined dose of product, with a substantially tubular and elongated shape, that has an extremity provided with a neck, at the top of which is defined a product dispensing mouth.

The opposite extremity of the containment body has an opening suitable for introducing the product, and is closed after filling, for example, by heat-sealing.

A closure, associable in a removable way with the container at the neck, allows the dispensing mouth to be closed.

The containment body and the closure can be made separately, using forming methods such as injection moulding, and can, afterwards, be assembled together. Alternatively, they can be made in a single piece and then separated before being used by a user.

The containment body, furthermore, has a pair of fins suitable for making it easier for a user to grip the container. The fins extend, diametrically opposite one another, from the outer side surface of the containment body itself.

The known containers can be produced in single units, or associated the one with the other in series (strips). In this latter case, the fins of the containment bodies of two successive containers are temporarily associated the one with the other at predefined pre-breaking lines.

With particular reference to the closure and to its shape according to the different ways of using and manufacture, different types of containers are known.

A first type of known container includes a cap having a portion fixed to the neck, during the moulding phase and along pre-established breaking areas, to close the dispensing mouth.

The cap also comprises a cavity suitable for housing or receiving the neck of the container, receiving with a shutter element for occluding the dispensing mouth, and initially turned towards the outside, in the opposite direction, with respect to the portion initially fixed to the neck.

The container is opened for the first time by detaching the cap from the dispensing mouth at the breaking areas and, after the product has been used, the container is closed again by turning the cap upside down and fitting the neck into the cavity, with the positioning of the shutter element inside the dispensing mouth.

The particular shape of the cap, however, results in the possible exposure of the cavity and of the shutter element to external polluting agents before the first use of the container, and does not therefore guarantee the integrity of the product during subsequent uses.

To restrict the possibility of product contamination, a second type of reclosable container is known, made in a single body, which includes a closure with a shutter element, such as a pin or the like, fitted and sealed inside the dispensing mouth. Deformable or breakable elements connect, without interruption, the closure to the container body.

Such deformable or breakable elements are suitable for indicating to the user the possible presence of product contaminations due to any tampering and/or accidental opening of the product, thus performing a tamper-evident function.

A third type of container is also known in which the closure and the containment body are made in separate pieces, and subsequently assembled together.

The closure for such containers generally comprise a handle with a shutter element, such as a pin or the like, that can be fitted inside the dispensing mouth to seal same, and an annular collar fixable coaxially, by means of interlocking, heat-sealing or gluing, to the neck of the containment body.

The handle is associable in a removable way at the outer surface of the collar by means of an opportune weakened area, composed of pre-breaking lines, of tearable bridges, of reduced cross sections, etc.

The handle, the collar and the pin are therefore made in a single piece or molding, separately from the containment body, and the collar is subsequently fixed to the neck by interlocking, heat-sealing or gluing, with the dispensing mouth being closed by means of the pin.

These known containers do, however, have some drawbacks.

In this respect, the fact is underlined or underscored that for some particular applications, the products contained in the containers must be mixed together before use.

For this purpose, two different containers have to be opened and the contents of each poured into a container able to receive them before the mix, thus obtained, is used.

The dual operation of opening, and pouring, obviously represents a disadvantageous additional operation of little practicality and requires execution times that are not negligible. Furthermore, it is necessary to have two or more separate containers, with consequent increase in overall dimensions.

To overcome such drawbacks at least in part, containers have been developed for pharmaceutical, cosmetic, food products or the like, in which the containment body is split up into two or more compartments by means of a dividing wall, each compartment being intended to contain different fluid products (DE 20 17 292).

Furthermore, for each compartment, a corresponding dispenser mouth opens, which is closable by means of a respective shutter element. Once the shutter elements have been removed, the squeezing of the container results in the simultaneous outflow of the fluid products.

These upgraded containers are however also susceptible to further upgrading, or improvement, aimed, in particular, at increasing their practicality and efficiency of use.

In this respect, the fact is underlined or underscored that containers with a dividing wall, the outflow of the fluid products occurs without these mixing intimately together, or else with only partial mixing.

For some types of fluid products on the other hand, it is opportune or desirable, or even necessary that, before the application, a particularly high degree of product mixing and/or homogenization be achieved.

Other kinds of containers are known from FR 2 029 825 and from U.S. Pat. No. 5,934,515.

### SUMMARY OF THE INVENTION

The main object of the present invention is to provide a container for fluid products, particularly pharmaceutical, cosmetic, food products or the like, that can be used in a practical, easy, functional and rapid way and, at the same time, possessing particularly compact and reduced overall dimensions.

Another object of the present invention is to provide a container for fluid products, particularly pharmaceutical, cosmetic, food products or the like, that allows intimately mixing two or more fluid products without any particular difficulties for the user.

Another object of the present invention is to provide a container for fluid products, particularly pharmaceutical, cosmetic, food products or the like, that overcomes the mentioned drawbacks of the background art, in the ambit of a simple, rational, easy, effective to use and low cost solution.

The above-described objects are achieved by the present container for fluid products, particularly pharmaceutical, cosmetic, food products or the like, according to claim 1.

The above described objects are achieved by the present container for fluid products, particularly pharmaceutical, cosmetic, food products, or the like, which employs a mixing element, which is secured to the neck of the container to define a mixing chamber for mixing, or blending together, the fluid products existing from the mouths formed in the container. The mixing element is adjusted, in the longitudinal direction, between two stable positions.

### BRIEF DESCRIPTION OF THE DRAWINGS

Other characteristics and advantages of the present invention will become more evident from the description of a preferred embodiment of a container for fluid products, particularly pharmaceutical, cosmetic, food products or the like, illustrated purely as an example but not limited to the annexed drawings in which:

FIG. 1 is an axonometric view of a preferred embodiment of containers according to the invention collected in a strip;

FIG. 2 is an exploded perspective view of one of the containers in FIG. 1 prior to assembly;

FIG. 3 is a longitudinal section view of the container in FIG. 2 in an assembled configuration;

FIG. 4 is an axonometric view, from another angle, of the container in FIG. 2;

FIG. 5 is a longitudinal section view of the container in FIG. 2 after opening, but before use;

FIG. 6 is a cross section view along the VI-VI plane in FIG. 5;

FIG. 7 is an axonometric view of an alternative embodiment of the container according to the invention;

FIG. 8 is a longitudinal section view of the container in FIG. 7 after opening before use; and

FIG. 9 is an axonometric view of another embodiment of the container according to the invention.

### DETAILED DESCRIPTION OF THE EMBODIMENTS

With reference to such figures, by 1 is globally indicated a container for fluid products, particularly pharmaceutical, cosmetic, food products or the like.

In this respect, it must be specified that in this application, the term fluid products not only means liquid products, but also viscous products, for example, in the paste or the gel state, and powdered products, in particular very fine powders having great flowability.

With particular reference to the embodiment of the invention shown in figures from 1 to 5, the container 1 comprises a hollow body 2 that is intended to contain two fluid products P1, P2.

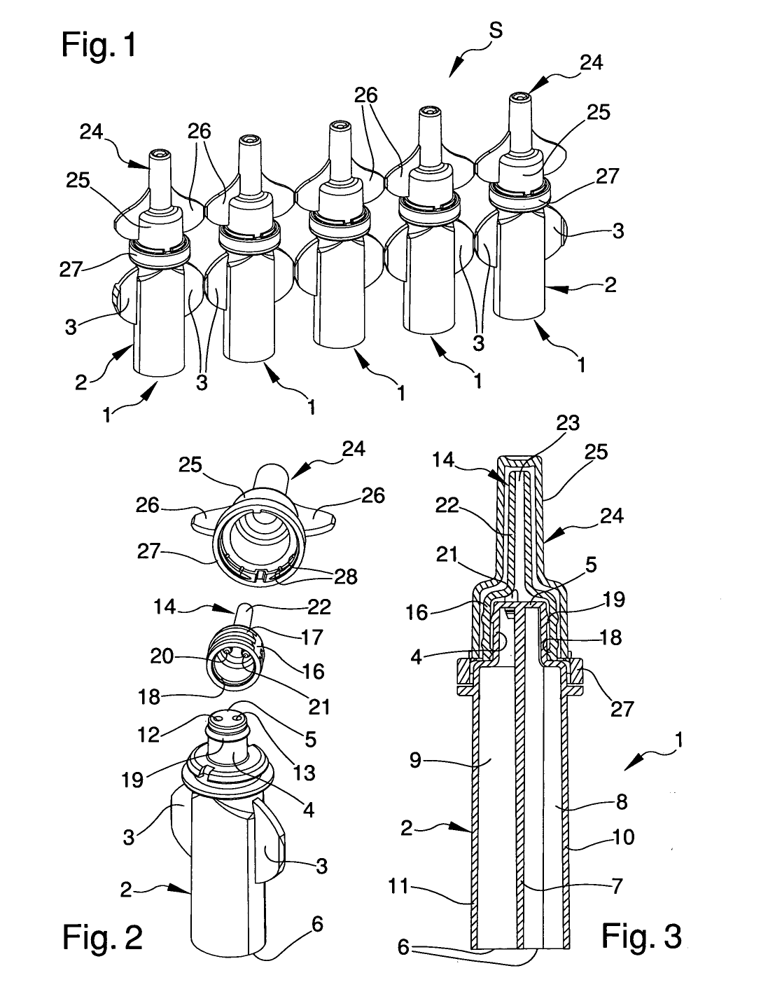

The hollow body 2 has a substantially tubular and elongated shape on the outer surface of which is defined a first pair of gripping fins 3 associable in a removable way with the first gripping fins 3 of one or more adjacent containers 1, so as to form a strip S of containers 1 (FIG. 1).

At its longitudinal extremity, the hollow body 2 extends into a neck 4 which has a substantially tubular and cylindrical shape with smaller diameter compared to the rest of the hollow body 2. The neck 4 is aligned coaxially with the hollow body 2 and ends in a transversal plate 5.

At the extremity of the hollow body 2 opposite the neck 4, an introduction opening 6 is provided for the filling of the container 1 with the fluid products P1, P2. The closing of the introduction opening 6 (for example by heat-sealing the lips of the opening itself) is done once the products have been introduced.

Usefully, inside the hollow body 2 is defined a dividing wall 7 suitable for splitting up the inner volume of the hollow body 2 into a first compartment 8 and a second compartment 9 intended to contain the fluid products P1, P2, respectively.

The dividing wall 7 extends along the entire length of the hollow body 2, from the neck 4 as far as the introduction opening 6.

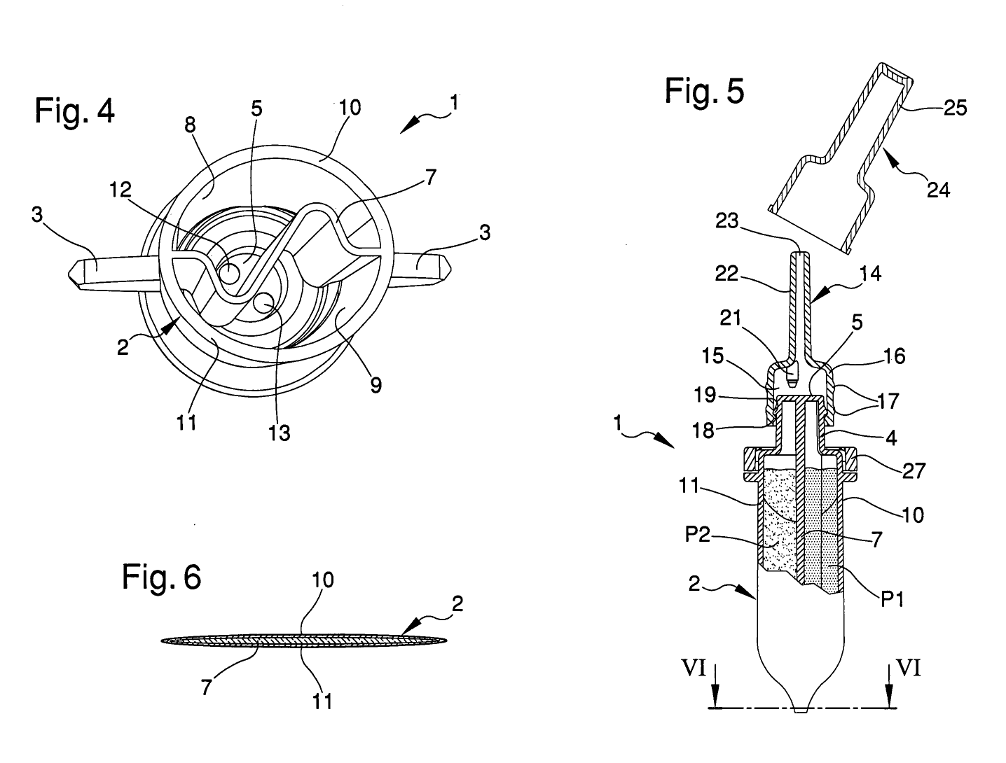

By means of the dividing wall 7, the tubular walls of the hollow body 2 are split up into a first wall 10, substantially curved, which together with the dividing wall 7 delimits the first compartment 8, and a second wall 11, substantially curved, which together with the dividing wall 7 delimits the second compartment 9; the first and the second walls 10, 11 are clearly shown in FIG. 4.

Moreover, the dividing wall 7 is at least in part bent on itself.

More in detail, by sectioning the hollow body 2 along a transversal plane, the dividing wall 7 is corrugated in shape and its extension in length is substantially equal to the length of the walls 10, 11 of the hollow body 2.

This particular layout of the dividing wall 7 means that when the hollow body 2 is squeezed, both the walls 10, 11 and the dividing wall 7 can be locally stretched along a direction transversal to the hollow body 2 and the walls 10, 11 can be moved into contact with the dividing wall 7.

This, in particular, is very useful during the closing phase of the introduction opening 6 (FIGS. 5 and 6), as it allows squeezing the lips of the introduction opening 6 on the dividing wall 7 without forming ruffles that could negatively affect the heat-sealing and jeopardise the seal and the preservation of the fluid products P1, P2 inside the container 1.

For the outflow or discharge of the fluid products P1, P2 from the compartments 8, 9, the neck 4 has two dispenser mouths 12, 13, one for each compartment 8, 9, obtained through the transversal plate 5.

Alternative embodiments of the present invention are possible in which, inside the hollow body 2 two or more dividing walls 7 are present to define three or more compartments 8, 9 for containing three or more fluid products; obviously in this case the neck 4 has three or more dispensing mouths 12, 13.

Advantageously, the container 1 comprises a mixing element 14 which is associable with the neck 4 to define a mixing chamber 15 for mixing the fluid products P1, P2 flowing out of the dispenser mouths 12, 13.

The mixing element 14 comprises a cap 16, substantially cylindrical in shape, fitted tightly on the neck 4. The cap can slide longitudinally between a first operating position, in which the cap 16 is located adjacent to the dispenser mouths 12, 13, and a second operating position, in which the cap 16 is located substantially away from the dispenser mouths 12, 13 and which, together with the transversal plate 5 of the neck 4, delimits the mixing chamber 15.

In detail, the cap 16 slides longitudinally on the neck 4 between the first operating position and the second operating position.

To make it easier for the mixing element 14 to slide, on the outer side surface of the cap 16 includes a plurality of substantially round shaped protruding ribs 17 which make it easier for the user to grip and apply force on it to move it from the first to the second operating position.

Usefully, suitable stop means 18, 19 are provided to retain the cap 16 in the second operating position.

The stop means 18, 19 are composed of a protrusion 18 which is defined on the inner surface of the cap 16 and a locator tooth 19 which is obtained at the longitudinal extremity of the neck 4 and can be coupled with the protrusion 18 to prevent the cap 16 from being completely extracted from the neck 4.

Usefully, the container 1 has closing means 20, 21 for closing the dispenser mouths 12, 13.

The closing means 20, 21 are defined by two shutter elements that fit into, and seal, the dispenser mouths 12, 13.

The shutter elements 20, 21 are shaped to define pins inside the cap 16, substantially parallel with one another, and with the longitudinal direction of the neck 4.

This way, once the cap 16 has been shifted to the first operating position, the shutter elements 20, 21 are fitted in the dispenser mouths 12, 13 so as to hermetically close the compartments 8, 9 and safeguard the fluid products P1, P2 contained in them.

In the switch from the first to the second operating position, on the other hand, the cap 16 shifts the shutter elements 20, 21 removing them from the dispenser mouths 12, 13 to allow the fluid products P1, P2 to come out, or exit.

The mixing element 14 also includes an applicator spout 22, which is shaped substantially elongated. An exit opening 23 allows the fluid products P1, P2 to come out or exit from the mixing chamber 15.

To close the exit opening 23, the container 1 has specific shutter means 24.

In the embodiment of the invention shown in the figures from 1 to 6 the shutter means 24 are composed of a covering element 25 fittable on the mixing element 14 to cover the exit opening 23.

The covering element 25 is shaped to define two second gripping fins 26 which, in the strip conformation S shown in the FIG. 1, are associable or joined in a removable way with the second gripping fins 26 of the adjacent containers 1.

To prevent the fluid products P1, P2 inside the hollow body 2 from being purposely, or accidentally, altered without the user noticing, the container 1 has seal anti-tampering indicator 27, 28 that is suitable for showing that the container 1 has been opened.

The seal anti-tampering indicator 27, 28 is made up of a collar 27, of annular shape, which is connected to the covering element 25 along pre-established fracture areas 28.

The pre-established fracture areas 28 are composed of a series of tearable bridges that connect the inner surface of the collar 27 to the edge of the cap 16.

The collar 27 can be fitted around the neck 4 and is intended to be made integral with this, for example by means of a slot-in locking system, or by gluing or, yet again, by sealing (ultrasonic, heat-sealing, or of other type).

It is further specified that the covering element 25, the second gripping fins 26 and the collar 27 are made in a single body, using a forming method, such as injection moulding, and polymer materials of the polyethylene or polypropylene type.

Similarly, the same forming method can be used to obtain the shutter elements 20, 21, the cap 16 and the spout 22 in a second single monolithic body, as well as the hollow body 2 and the dividing wall 16 to define a third single monolithic body.

The hollow body 2 and the dividing wall 7 are therefore initially separated both from the mixing element 14, and from the covering element 25, as shown in FIG. 2.

The container 1 is assembled at a later stage by locating, or shading, onto the mixing element 14 the neck 4 as far as the first operating position, with contemporaneous fitting of the shutter elements 20, 21 inside the dispenser mouths 12, 13, and therefore making the covering element 25 fit on the mixing element 14, and joining the collar 27 integral with the neck 4.

The container 1 thus assembled is shown in FIG. 3.

After assembly, the compartments 8, 9 can be filled with the fluid products P1, P2 causing them to pass through the introduction opening 6, which is intended to be closed at the end of the filling operation.

The fluid products P1, P2, therefore, stay inside the hollow body 2 until they are used by the end user.

In order for them to outflow from the container 1, in sequence, the covering element 25 is removed, tearing the tearable bridges 28, the mixing element 14 is moved from the first operating position to the second operating position, thereby freeing the dispenser mouths 12, 13 from the shutter elements 20, 21. Finally, the fluid products P1, P2 are dispensed by squeezing the walls 10, 11 of the hollow body 2.

During outflow, the fluid products P1, P2 move from the compartments 8, 9 to the mixing chamber 15, where they mix together before exiting through the spout 22.

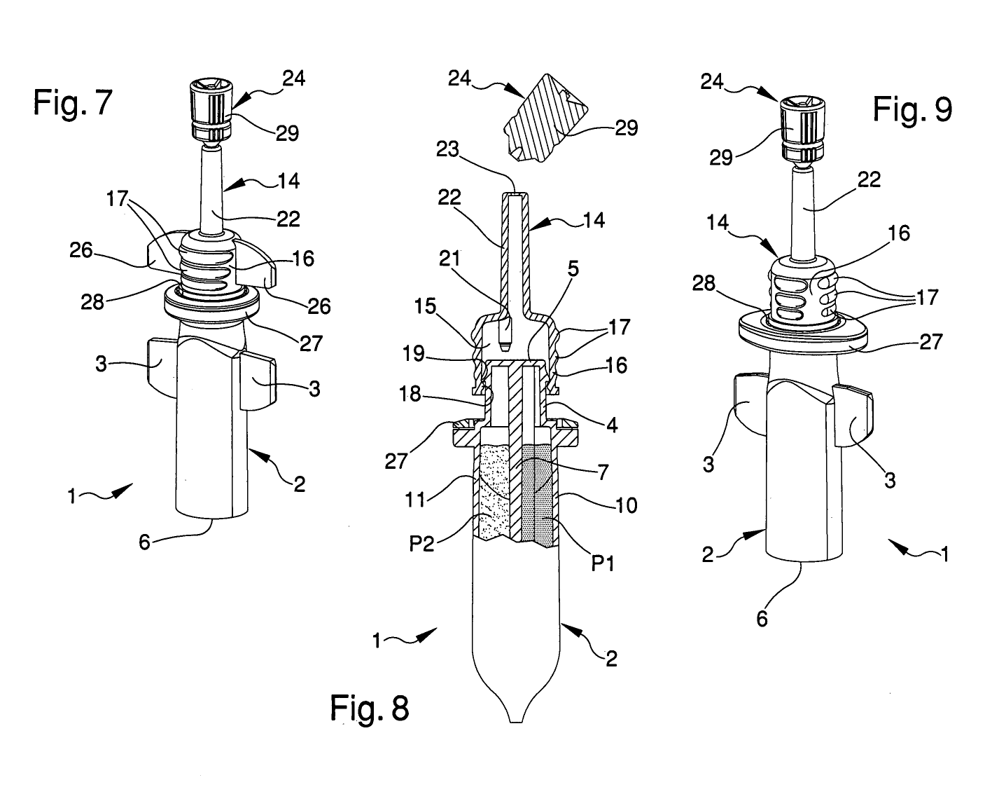

An alternative embodiment of the invention is shown in the FIGS. 7 and 8.

In this embodiment, the container 1 has a hollow body 2 with a dividing wall 7 and a neck 4 substantially identical to those of the preceding embodiments and which, therefore, will not be the subject of a further detailed explanation, and it remains understood that for these it is best to make reference to the above description.

In the embodiment of the FIGS. 7 and 8, furthermore, the mixing element 14 comprises a cap 16 with shutter elements 20, 21, and a spout 22 with the exit opening 23, with the difference however, that the shutter means 24 are not made up of a covering element 25 but instead of a plug element 29 associated with the exit opening 23 along a removable rip-off tearable line.

In the case of this embodiment too, the container 1 has second gripping fins 26 which, unlike the above, are associated with the cap 16 of the mixing element 14.

At the base of the cap 16, furthermore, are also associated the seal anti-tampering means 27, 28 composed of a collar 27 identical to that in the figures from 1 to 6, with the difference that, by means of the tearable bridges 28, it is connected directly to the open edge of the cap 16.

In this embodiment, in point of fact, the cap 16, the spout 22, the shutter elements 20, 21, the shutter means 24 and the collar 27 are initially made in a single monolithic body intended to be fitted on the neck 4 of the hollow body 2 after forming.

In an assembly configuration (FIG. 7), the collar 27 is made integral with the neck 4, the cap 16 is arranged or located in the first operating position and the exit opening 23 is closed by the plug element 29.

Before using therefore, the plug element 29 must be torn from the exit opening 23 and the cap 16 must be made to slide along the neck 4 until it is in the second operating position, thereby freeing the dispenser mouths 12, 13 and allowing the fluid products P1, P2 to come out (FIG. 8).

Other embodiments of the present invention cannot however be ruled out such as, e.g., that shown in FIG. 9.

This embodiment is substantially the same as that in the FIGS. 7 and 8 and differs from this only inasmuch as the cap 16 is without the second gripping fins 26 and that in their place are defined a further two series of protruding ribs 17 that make it easier for the end user to grip the cap 16.

It has in practice been shown how the described invention achieves the intended objects.

In this respect, the fact is underlined that the particular solution of providing the mixing element according to the invention allows obtaining a container for fluid products, particularly pharmaceutical, cosmetic, food products or the like, within which the fluid products can be mixed and then dispensed, once mixed, in a practical, easy and functional way.

1. Container for fluid products, particularly pharmaceutical, cosmetic, food products or the like, comprising at least a hollow body inside which is defined at least a dividing wall suitable for splitting up the inner volume of said hollow body into at least a first compartments and a second compartment for containing at least two fluid products respectively, at least a neck which extends from said hollow body and which has at least two dispenser mouths for said fluid products, closing means for said dispenser mouths, and at least a mixing element which is associable with said neck defining a mixing chamber for mixing said fluid products exiting from said dispenser mouths, said hollow body having tubular walls which are split up into a first wall, which together with said dividing wall delimits said first compartment, and a second wall, which together with said dividing wall delimits said second compartment, wherein, by sectioning said hollow body along a transversal plane, the extension in length of said dividing wall is substantially equal to the length of said walls, when the hollow body is squeezed, both the walls and the dividing wall being able to be locally stretched along a direction transversal to the hollow body and the walls being able to be moved into contact substantially coinciding with the dividing wall.

2. Container according to claim 1, wherein said mixing element comprises at least a cap substantially fitted on said neck and moving between a first operating position, in which it is arranged substantially close to said dispenser mouths, and at least a second operating position, in which it is arranged substantially away from said dispenser mouths.

3. Container according to claim 2, wherein said cap is sliding longitudinally on said neck between said first operating position and said second operating position.

4. Container according to, claim 2, wherein it comprises stop means of said cap in said second operating position.

5. Container according to claim 4, wherein said stop means comprise at least a protrusion defined on at least one between said cap and said neck and at least a locator tooth obtained on the other between said cap and said neck and which can be coupled with said protrusion.

6. Container according to claim 1, wherein said closing means comprise at least two shutter elements fittable sealed in said dispenser mouths.

7. Container according to claim 6, wherein said shutter elements are defined by respective pins substantially parallel with each other.

8. Container according to claim 6, wherein:
said mixing element comprises at least a cap substantially fitted on said neck and moving between a first operating position, in which it is arranged substantially close to said dispenser mouths, and at least a second operating position, in which it is arranged substantially away from said dispenser mouths and
said shutter elements are associated with said cap, in said first operating position of the cap said shutter elements being arranged inserted in said dispenser mouths and in said second operating position of the cap said shutter elements-being arranged extracted from said dispenser mouths.

9. Container according to claim 1, wherein said mixing element comprises at least an exit opening of said fluid products from said mixing chamber.

10. Container according to claim 9, wherein said mixing element comprises at least a spout substantially elongated on which said exit opening is obtained.

11. Container according to claim 9, wherein it comprises shutter means of said exit opening.

12. Container according to claim 11, wherein said shutter means comprise at least a covering element fittable on said mixing element to cover said exit opening.

13. Container according to claim 11, wherein said shutter means comprise at least a plug element associated with said exit opening along at least a removable rip-off tearable line.

14. Container according to claim 1, wherein it comprises seal anti-tampering means which are suitable for showing the opening of said container.

15. Container according to claim 12, wherein it comprises seal anti-tampering means which are suitable for showing the opening of said container and said seal anti-tampering means comprise at least a collar which is associable with said hollow body and is connected to said covering element along at least a pre-established fracture area.

16. Container according to claim 2, wherein it comprises seal anti-tampering means which are suitable for showing the opening of said container and said seal anti-tampering means comprise at least a collar which is associable with said hollow body and is connected to said cap along at least a pre-established fracture area.

17. Container according to claim 1, wherein said hollow body has an outer surface on which a first pair of gripping fins is defined, said first pair of gripping fins being associable in a removable way with the first gripping fins of one or more adjacent containers, to form a strip of containers.
